(19) United States
(12) Patent Application Publication
(10) Pub. No.: US 2025/0123799 A1
(43) Pub. Date: Apr. 17, 2025

(54) Voice-Enabled Virtual Object Disambiguation and Controls in Artificial Reality

(71) Applicant: Meta Platforms, Inc., Menlo Park, CA (US)

(72) Inventors: William CHERRY, Los Angeles, CA (US); Bret HOBBS, Moraga, CA (US)

(21) Appl. No.: 18/488,482

(22) Filed: Oct. 17, 2023

Related U.S. Application Data
(60) Provisional application No. 63/380,275, filed on Oct. 20, 2022.

(51) Int. Cl. G06F 3/16; G06F 3/01; G06T 11/00; G10L 15/18

(52) U.S. Cl. CPC G06F 3/167; G06F 3/013; G06T 11/00; G10L 15/1815

(57) ABSTRACT

Aspects of the present disclosure are directed to applying voice controls to a target virtual object in an artificial reality environment. User controls in an artificial reality environment can take many forms. Some user controls, such as ray casting or gaze tracking, can incorporate selection mechanics to select the artificial reality environment element (e.g., virtual object) that the user is targeting for interaction. Other forms of user controls, such as voice controls, may not include such selection mechanics. Implementations disambiguate user voice input to select a target virtual object and control the target virtual object based on the voice input. For example, a disambiguation and control layer can select the virtual object the user intends to target with voice input, format input for the target virtual object using the voice input, and control the target virtual object via execution of one or more applications that manage the virtual object.

### CROSS-REFERENCE TO RELATED APPLICATIONS

This application claims priority to U.S. provisional patent application No. 63/380,275, filed Oct. 20, 2022, titled “Voice-enabled Virtual Object Capabilities in MR Player,” which is herein incorporated by reference in its entirety.

### TECHNICAL FIELD

The present disclosure is directed to applying voice controls to a target virtual object in an artificial reality environment.

### BACKGROUND

Augmented reality (AR) or mixed reality (MR) are interactive experiences of a real-world environment where the objects that reside in the real world are enhanced by computer-generated perceptual information, sometimes across multiple sensory modalities, including visual, auditory, haptic, somatosensory and olfactory. AR and/or MR can incorporate three features: a combination of real and virtual worlds, real-time interaction, and accurate three-dimensional registration of virtual and real objects. The overlaid sensory information can add to the natural environment or mask the natural environment. This experience is seamlessly interwoven with the physical world such that it is perceived as an immersive aspect of the real environment. In this way, AR and/or MR alter a user's ongoing perception of a real-world environment.

Virtual reality (VR) is a simulated experience that can be similar to or completely different from the real world. Applications of VR include entertainment, education, business, and many others. Conventional VR systems use either VR headsets or multi-projected environments to generate realistic images, sounds, and other sensations that simulate a user's physical presence in a virtual environment. A user of a VR system is able to look around the artificial world, move around in it, and interact with virtual features or items. The effect is commonly created by VR headsets that comprise a head-mounted display with screens in front of the user's eyes, but can also be created through specially designed rooms with multiple large screens.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the disclosed technology can operate.

FIG. 4 is a block diagram illustrating an overview of an environment in which some implementations of the present technology can operate.

FIG. 5A is a conceptual diagram illustrating an example data flow for disambiguating user voice and providing formatted input to control a targeted virtual object.

FIG. 5B is a conceptual diagram of an example disambiguation and control layer.

FIG. 5C is a conceptual diagram of an example target virtual object input data format.

FIG. 6 is a conceptual diagram of an example of launching a targeted virtual object in an artificial reality environment.

FIG. 7 is a conceptual diagram of an example of selecting and controlling a targeted virtual object among multiple virtual objects in an artificial reality environment.

FIG. 8 is a flow diagram illustrating a process used in some implementations of the present technology for applying voice controls to a target virtual object in an artificial reality environment.

FIG. 9 is a flow diagram illustrating a process used in some implementations of the present technology for implementing controls via generated virtual object input.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to applying voice controls to a target virtual object in an artificial reality environment. User controls in an artificial reality environment can take many forms, such as gaze tracking, ray casting via the user's body or a hand-held controller, user hand tracking, voice controls, and many others. Some forms of user controls, such as ray casting or gaze tracking, can incorporate selection mechanics, for example to select the artificial reality environment element (e.g., virtual object) that the user is targeting for interaction. Others forms of user controls, such as voice controls, may not include such selection mechanics. Implementations disambiguate user voice input to select a target virtual object and control the target virtual object based on the voice input. For example, a disambiguation and control layer can select the virtual object the user intends to target with voice input, format input for the target virtual object using the voice input, and control the target virtual object via execution of one or more applications that manage the object.

The disambiguation and control layer can process user voice input to control targeted virtual object(s). For example, a transcript of an instance of user voice input can be generated. The disambiguation and control layer can derive one or more user intentions from the voice input/transcript. In some implementations, the determined user intentions can be selected from a predefined set of user intentions. In some implementations, a trained machine learning model (e.g., natural language processing model) can predict user intentions based on the voice input/transcript (and in some cases additional context such as gaze direction, interaction history, etc.). Using the voice input, transcript, and/or derived user intentions, the disambiguation and control layer can predict a target virtual object from a plurality of potential virtual objects. For example, analytical model(s) (e.g., trained machine learning model, rule-based model, etc.) can be configured to select the target virtual object from among a predetermined set of potential virtual objects using the voice input, transcript, and/or derived user intentions.

Once the target virtual object is selected, the disambiguation and control layer can access input types for the target virtual object. The input types can be data structures (e.g., format for input data) that are compatible with controlling the target virtual object. In some implementations, the target virtual object registers the input types with the disambiguation and control layer. The different input types for the target virtual object can correspond to different target virtual object functionality. In some implementations, a trained machine learning model can select an input type from the target virtual object's set of candidate input types.

Once the input type is selected, the disambiguation and control layer can generate target virtual object input in accordance with the selected input type. For example, the selected input type can define parameters to pass to the target virtual object in order to accomplish the virtual object control (e.g., trigger the virtual object functionality that corresponds to the selected input type). In some implementations, the generated target virtual object input is provided to one or more applications that manage the target virtual object. Target virtual object control is accomplished via executing the managing application(s), such as execution that is responsive to the target virtual object input.

In this example, the selected target virtual object and the selected input type for the target virtual object represent disambiguated voice control. Though the user's voice input does not include an explicit mechanism for selecting the target virtual object, the disambiguation and control layer detects the target virtual object, resolves the user's intended virtual object functionality, and generates control data that triggers the intended virtual object functionality.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Conventional XR systems rely on input channels with explicit selection mechanics to select a target virtual object for user input, such as gaze tracking, ray-based interactions, or other suitable user input associated with a location (e.g., cursor location) within an XR environment. However, these systems fail to effectively select a target for user input when these explicit selection mechanics are absent. To select a target for voice input, these convention XR systems rely on either another input channel with explicit selection mechanics or explicit user voice instruction that directly defines the target virtual object. Such conventional systems lack flexibility and/or require user instructions that render the systems impractical, inefficient, and degrade the user experience.

Implementations include a disambiguation and control layer that effectively selects a target virtual object for user voice input. The selection can be made with the assistance of another input channel (e.g., gaze tracking, ray-based interaction channels, stored user interaction histories, etc.) or in the absence of such channels. For example, the disambiguation and control layer can include analytical model(s) that predict the target virtual object using the user's voice input, derived intentions from the user's voice input, a user interaction history with virtual objects, or a combination thereof. Once the target virtual object is selected, the disambiguation and control layer can also provide target virtual object input to the application(s) that manage the target virtual object such that execution of these application(s) effectively controls the target virtual object. For example, the disambiguation and control layer can select an input format/structure that is compatible with the managing application(s) and generate the target virtual object input in accordance with the input format/structure. Accordingly, the disambiguation and control layer can effectively select a target virtual object and support control of the target virtual object without explicit selection mechanics or explicit user instructions that target the virtual object.

In some implementations, the disambiguation and control layer also enforces security and/or privacy policies for the user, XR system, or managing application(s). For example, the disambiguation and control layer may be part of native XR system software (e.g., system shell, runtime environment, etc.), and thus may have a higher degree of access to user information than the managing application(s), which may be third-party XR applications. The disambiguation and control layer passes limited information to the managing application(s), such as the information required by the application(s) to control the virtual object. Other user information, such as the raw voice data, may be secured from the managing application(s). Thus, the disambiguation and control layer improves flexibility and the user experience while enforcing privacy and security policies.

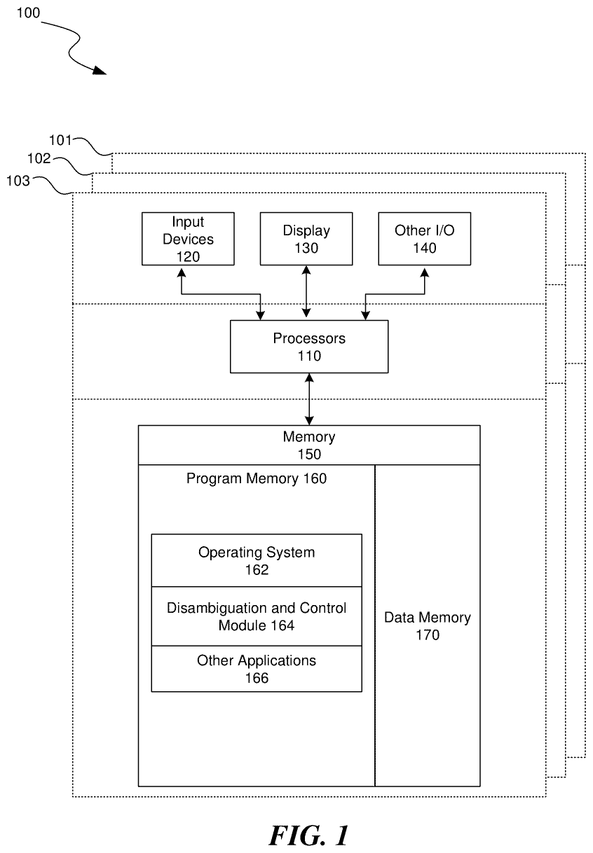

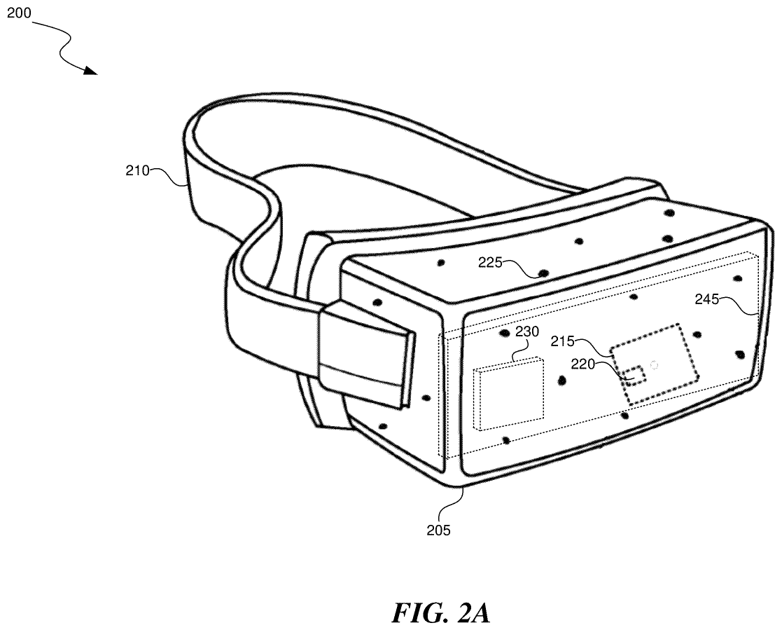

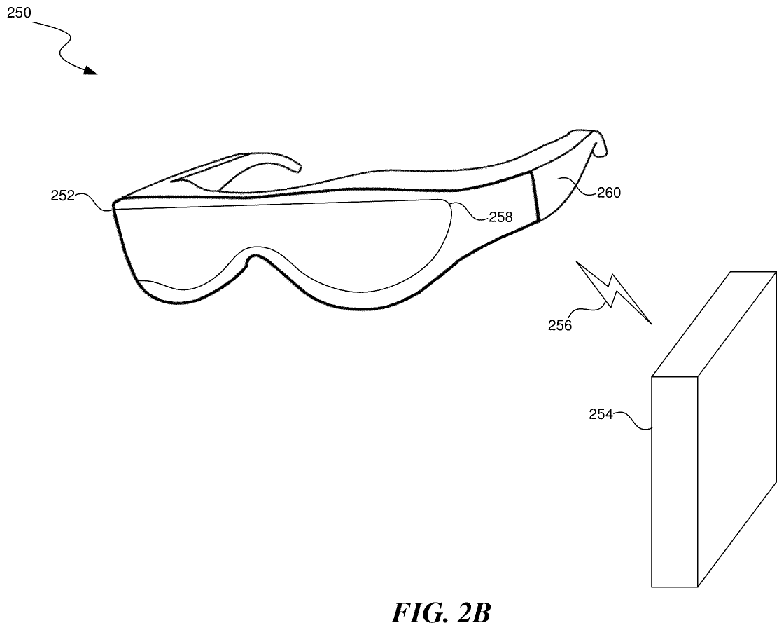

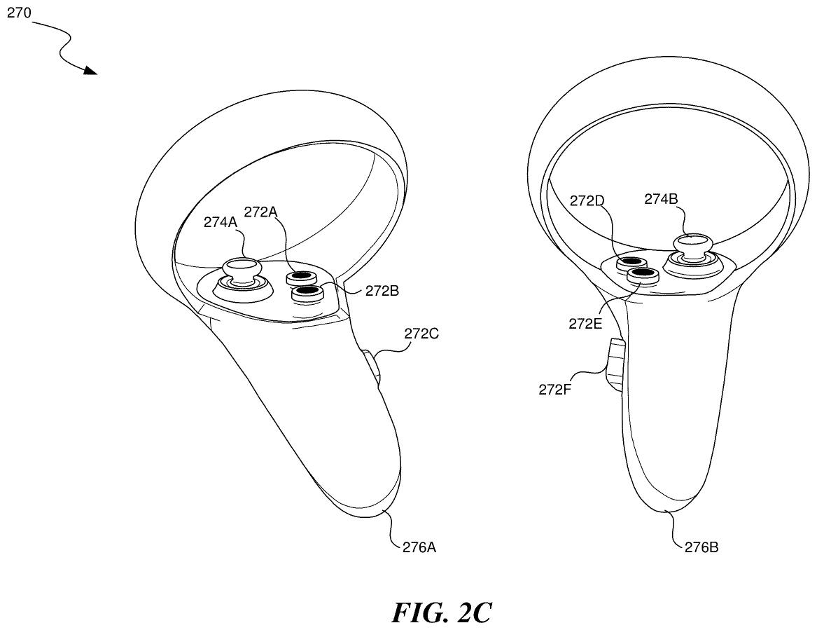

Several implementations are discussed below in more detail in reference to the figures. FIG. 1 is a block diagram illustrating an overview of devices on which some implementations of the disclosed technology can operate. The devices can comprise hardware components of a computing system 100 that apply voice controls to a target virtual object in an artificial reality (XR) environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, disambiguation and control module 164, and other application programs 166. Memory 150 can also include data memory 170 that can include, e.g., audio data, transcript(s), input type templates, metadata (e.g., intent(s), entities from voice input, etc.), configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

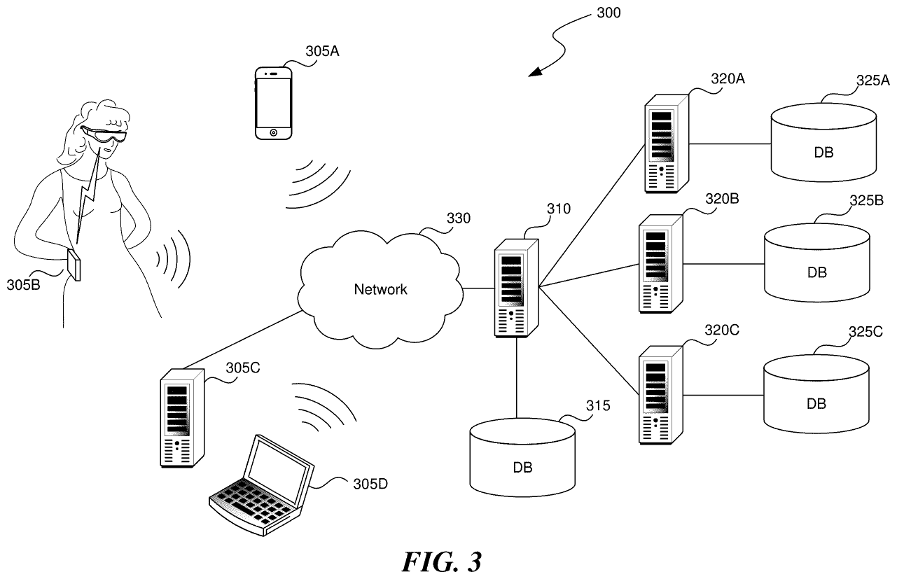

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

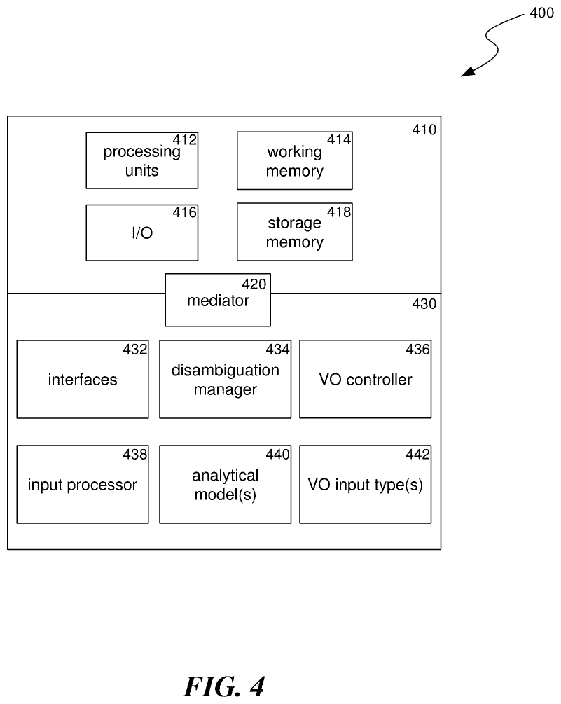

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for applying voice controls to a target virtual object in an artificial reality (XR) environment. Specialized components 430 can include disambiguation manager 434, virtual object (VO) controller 436, user input processor 438, analytical model(s) 440, virtual object (VO) input type(s) 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

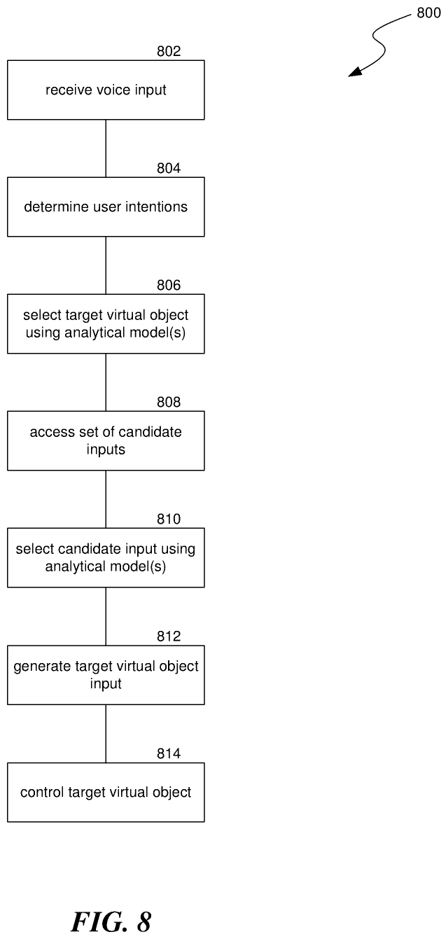

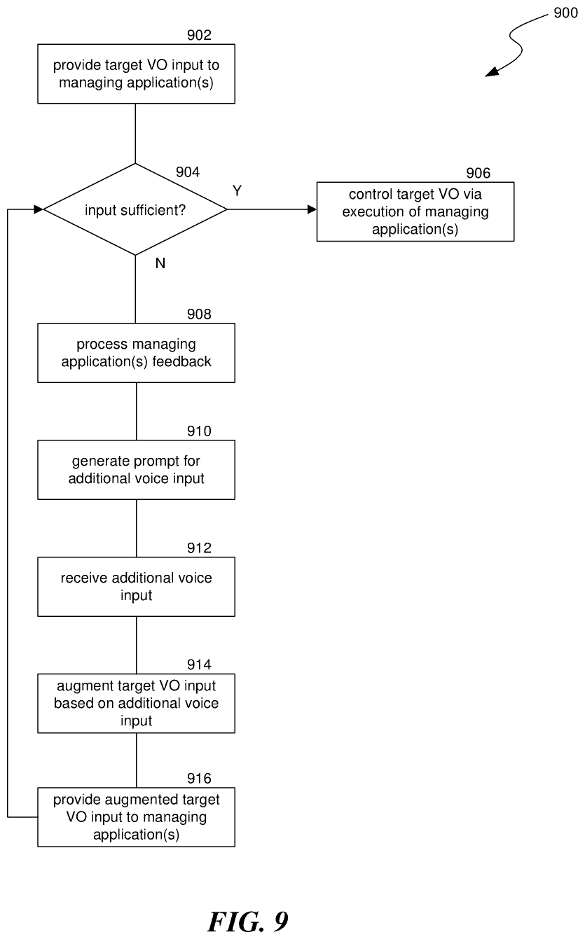

Disambiguation manager 434 can select a target virtual object for voice input from a user. For example, voice input from a user can be received in various circumstances, and disambiguation manager 434 can select the virtual object targeted by the user and the user's voice input. In some implementations, input processor 348 can process the voice input to generate a transcript and/or derive user intention(s) from the voice input. Disambiguation manager 434 can provide data elements (e.g., transcribed voice input, derived user intention(s), etc.) to one or more analytical model(s) 440 configured to predict the virtual object targeted by the voice input. In some implementations, a target virtual object can be one that has not yet been instantiated in the artificial reality environment, but that an available application can create. Once selected, disambiguation manager 434 can provide the target virtual object to virtual object controller 436, which can generate target virtual object input for the target virtual object. Further details regarding disambiguation manager 434 are described with respect to blocks 804, 806, 808, 812, and 814 of FIG. 8 and blocks 902, 906, 908, 910, 912, 914, and 916 of FIG. 9.

Virtual object controller 436 can generate target virtual object input for a target virtual object, such as in accordance with virtual object input type(s) 442. A given target virtual object can comprise a set of candidate input types (e.g., virtual object input type(s) 442 with respect to the given target virtual object) that are compatible with the virtual object. For example, an input type compatible with a given target virtual object can provide suitable information that can be used to control the given target virtual object (e.g., alter the display of the virtual object, launch a display for the target virtual object, etc.). For a given instance of voice input from a user and a given target virtual object, virtual object controller 436 can select one or more of the set of the candidate input types. In some implementations, virtual object controller 436 provides data elements (e.g., target virtual object identifier, transcribed voice input, derived user intention(s), set of candidate input types, etc.) to one or more analytical model(s) 440 configured to predict the candidate input type(s) that corresponds to an instance of voice input. Once selected, virtual object controller 436 can generate target virtual object input in accordance with the selected input type. For example, the selected input type may comprise a data format (e.g., VO action, first parameter; VO action, first parameter, second parameter, etc.) and virtual object controller 436 can generate the target virtual object input according to the data format. Virtual object controller 436 can generate the target virtual object input using the transcribed voice input, derived user intention(s), template for the selected input type, and any other suitable data. Further details regarding virtual object controller 436 are described with respect to blocks 808, 812, and 814 of FIG. 8 and blocks 902, 906, 908, 910, 912, 914, and 916 of FIG. 9.

Input processor 438 can process user input for applying voice controls to a target virtual object. Example user input includes voice input, tracked gaze input, tracked body input (e.g., tracked hand movement), tracked controller input, and any other suitable input. Input processor 438 can process voice input, such as transcribe the voice input into text. Input processor 438 can also process tracked gaze input to resolve the user's gaze with respect to an XR environment displayed to the user. In some implementations, the processed gaze input can comprise a user focus metric, such as a location in the XR environment, a gaze direction, a gaze region, or any other suitable gaze metric. Input processor 438 can also process tracked body input and/or tracked controller input. For example, an XR system can project a ray into an XR environment using tracked body movement (e.g., wrist, hand, arm etc.) and/or tracked controller movement (e.g., hand-held controller(s), etc.). Input processor 438 can also process other contextual input such as a history of user interactions, e.g., which virtual objects the user has recently interacted with, which the user has interacted with the most, which the user tends to interact with in similar physical circumstances, etc. Further details regarding input processor 438 are described with respect to blocks 802 and 804 of FIG. 8 and blocks 908, 910, 912, and 914 of FIG. 9.

Analytical model(s) 440 can be any suitable software models that can analyze information to generate predictions and/or make selections, such as machine learning model(s), numerical model(s), rule-based model(s), any combination thereof, or any other suitable analytical models. In some implementations, analytical model(s) 440 can be trained machine learning model(s), rule-based model(s), or a combination of these that predict a target virtual object from among multiple potential target virtual objects. In this example, analytical model(s) 440 can use one or more of a transcript of user voice input, derived intentions from the voice input, a virtual object interaction history, and/or a user focus metric to predict the target virtual object. Analytical model(s) 440 can also derive the user intention(s) from the voice input, such as one or more natural language processing models trained to understand user voice utterances and predict user intentions from these utterances. Analytical model(s) 440 can also predict an input type for a target virtual object from among multiple predefined input types. For example, trained machine learning model(s), rule-based model(s), or a combination of these can predict the input type using one or more of the voice input (or transcript), derived intention(s), target virtual object interaction history, or any combination thereof. Further details regarding analytical model(s) 440 are described with respect to blocks 804, 806, and 810 of FIG. 8 and blocks 908, 910, and 914 of FIG. 9.

Virtual object input type(s) 442 can comprise templates for input type(s) that correspond to different virtual objects. Different virtual objects can comprise different functions. For example, a music player virtual object can comprise functions such as: open player; close player; play music; stop music; play podcast; search for particular artist, song, album; play a particular artist, song, or album; and any other suitable music player functionality. In another example, a virtual object that comprises an animated character can comprise functions such as: display character; remove character display; dance; sing; play a particular song; change the color of your hat; change your hat color to blue; dance in a particular style (e.g., hip-hop, modern, etc.) or perform a particular dance move; and any other suitable animated character functions. These different virtual object functions can correspond to different input formats. For example, the music player virtual object can take input to play a particular song, a particular artist, a particular album, and the like. Similarly, the animated character can take input to dance, dance in a particular style, perform a particular dance move, etc. For a given virtual object, virtual object input type(s) 442 can define the input formats (e.g., parameters to pass to the virtual object) that correspond to the different functions of the virtual object. Further details regarding virtual object input type(s) 442 are described with respect to blocks 808, 810, and 812 of FIG. 8.

A “machine learning model,” as used herein, refers to a construct that is configured to make predictions, provide probabilities, augment data, and/or generate data. For example, training data (e.g., for supervised learning) can include items with various parameters, an assigned classification, or any other suitable data labels. The training data can include relationships among elements of the training data that can be learned by the machine learning model, such as semantic relationships among words, phrases, etc. New data item(s) can have parameters that a model can use to assign a classification to the new data item(s), generate data using the new data item(s), generate predictions based on the new data item(s), and the like. Examples of models include: neural networks, support vector machines, Parzen windows, Bayes, clustering models, reinforcement models, probability distributions, decision trees, natural language processing model(s) (e.g., large language models, specialized neural network such as recurrent neural networks, transforms models, etc.), encoder-decoder models, generative models (e.g., generative adversarial networks, generative large language models, generative encoder-decoder models, etc.) and others. Machine learning models can be configured for various situations, data types, sources, and output formats.

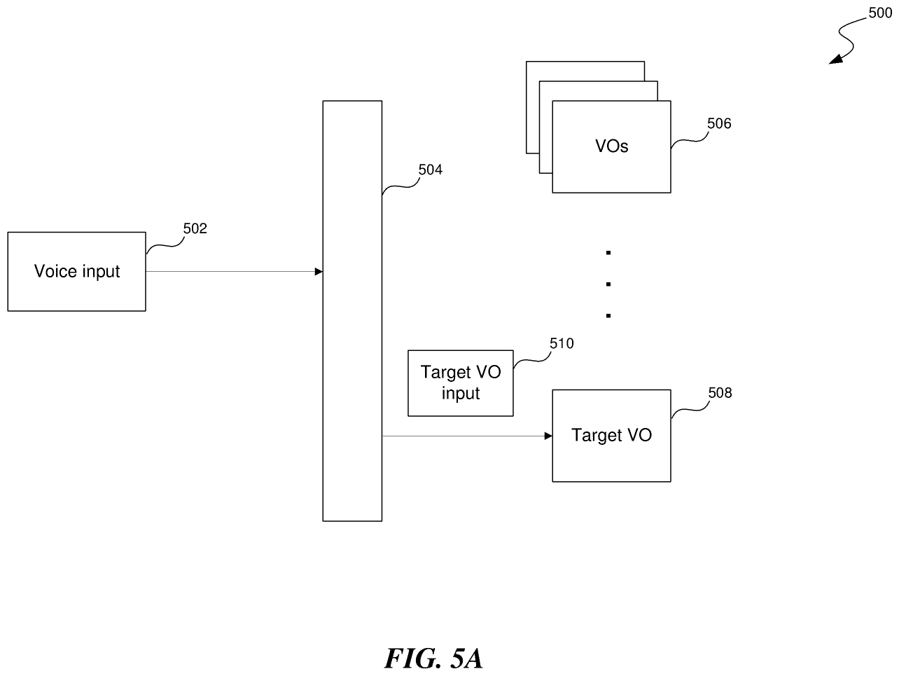

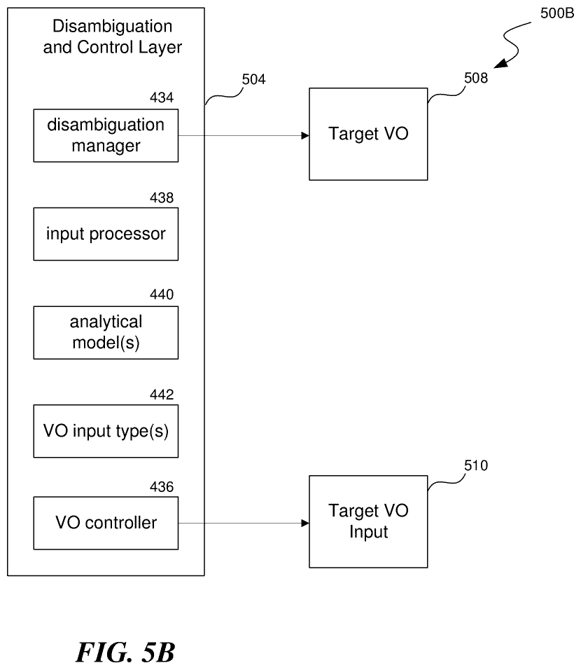

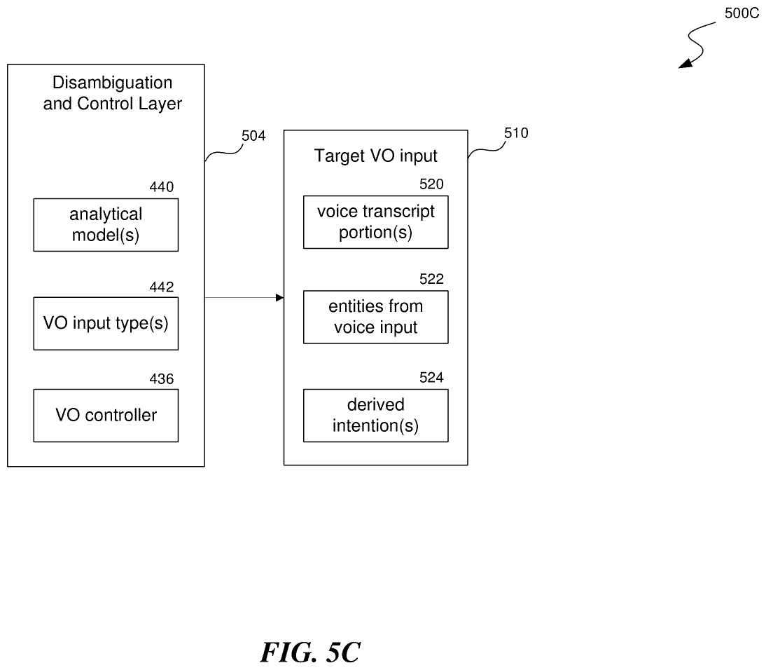

Implementations disambiguate a target for user voice input, such as a virtual object target, and control the target via controls, such as formatted virtual object target input that, when provided to application(s) that manage the virtual object, cause functionality from the target virtual object. FIG. 5A is a conceptual diagram illustrating an example data flow for disambiguating user voice and providing formatted input to control a targeted virtual object. Diagram 500A illustrates voice input 502, disambiguation and control layer 504, virtual objects 506, target virtual object 508, and target virtual object input 510.

An XR system can display an XR environment to a user. In some implementations, the XR environment is an MR environment that comprises a combination of real-world elements and virtual elements (e.g., virtual objects). Voice input 502 can be any suitable voice input from the user that is sensed by one or more audio sensors. The audio sensor(s) (e.g., microphone(s)) can be part of or operatively communicative with the XR system. In some implementations, disambiguation and control layer 504 is part of the native software of the XR system. Disambiguation and control layer 504 can process voice input 502 to transcribe the input, derive user intention(s) from the input, and select target virtual object 508. For example, target virtual object 508 can be selected from among virtual objects 506. In some implementations, a target virtual object can be one that has not yet been instantiated in the artificial reality environment, but that an available application can create. Once selected, disambiguation and control layer 504 can generate target virtual object input 510 for the selected target virtual object 508. The functionality of disambiguation and control layer 504 is further described with reference to FIGS. 5B and 5C.

Virtual objects 506 and target virtual object 508 can be any virtual objects that can be displayed in an XR environment and can be controlled via execution of one or more managing applications. Example virtual objects 506 and/or target virtual object 508 include: two-dimensional virtual objects (e.g., images or panels), three-dimensional virtual objects (e.g., objects with a skeleton/mesh structure and skin, such as texture), static virtual objects (e.g., images), dynamic virtual objects (e.g., animated images, three-dimensional objects, virtual objects with interfaces to external systems causing dynamic changes, etc.), or any other suitable virtual object. Virtual objects 506 and target virtual object 508 can comprise definition information used to display and control the virtual objects. Definition information for a static image virtual object can include the image file or an indicator for the image file (e.g., a network/device location for the image file). On the other hand, the definition information for a three-dimensional virtual object with multiple poses/display states can include: structure data (e.g., mesh structure, skeleton, etc.) and/or visual presentation data (e.g., textures/skin, other visual information), pose(s) and/or view(s) data, and other suitable data for rendering the three-dimensional virtual objects in various states. In some implementations, managing application(s) can display and/or control these virtual objects using their definition information.

For example, managing application(s) can include XR applications loaded and/or executing at the XR system. In some implementations, portions of the XR applications can execute at the XR system and portions can execute in a cloud system, edge system, or any other suitable system. The XR applications may provide content, display functionality, and/or control functionality for virtual objects 506 and target virtual object 508. In some implementations, the XR system can comprise a runtime environment that executes the managing application(s) and/or an XR system shell that executes along with the managing application(s). For example, the XR system shell can provide the managing application(s) information that supports virtual object controls and/or functionality.

In some implementations, disambiguation and control layer 504 is part of the XR system shell (or other software native to the XR system) and the managing application(s) comprise third-party applications. For example, disambiguation and control layer 504 may comprise data access rights for data that is restricted from the managing application(s), such as raw voice input from the user. Accordingly, disambiguation and control layer 504 can process voice input 502 and pass relevant data to the managing application(s) (e.g., target virtual object input 510) to support virtual object control and functionality.

In some implementations, target virtual object input 510 can be used by the managing application(s) to create and/or control the target virtual object, such as: dynamically instantiate and display the object, dynamically remove a display of the object, dynamically alter a display of the object (e.g., cause an object to change colors, more, animate an object, change text display via the object, etc.), and the like. In some implementations, control of target virtual object 508 is performed in correspondence with other functionality implemented by the managing application(s). For example, target virtual object input 510 that causes a change to music played via a music player virtual object can: alter the display of the music player virtual object so that a new song, title, or artist is displayed; and alter the music played via audio output components (e.g., speakers) of the XR system. Accordingly, disambiguation and control layer 504 can orchestrate both virtual object functionality and additional application functionality related to the virtual object functionality.

FIG. 5B is a conceptual diagram of an example disambiguation and control layer. Diagram 500B illustrates disambiguation and control layer 504 and target virtual object input 510, as well as disambiguation manager 434, virtual object controller 436, input processor 438, analytical model(s) 440, virtual object input type(s) 442 from FIG. 4. As disclosed with reference to FIG. 5A and diagram 500A, disambiguation and control layer 504 can execute at an XR system and can receive voice input from a user.

Input processor 438 can process the voice input to generate a transcript of the voice input and derive user intentions from the voice input. For example, user intentions can be any suitable language elements or identifiers that represent an intention from the voice input. In some implementations, user intentions comprise one or more verbs within the voice input. User intentions can be selected from a predefined set of user intentions and/or derived using analytical model(s) (e.g., natural language processing model(s)). For example, disambiguation and control layer 504 can store a predefined set of user intentions based on: the virtual objects and/or managing application(s) loaded at the XR system; different functions available at the XR system; registered capabilities of the virtual objects and/or managing application(s) loaded at the XR system; or any other suitable source for XR system functionality. Input processor 438 can derive intention(s) from the voice input by matching the predefined user intentions to the voice input, for example by applying a natural language processing model to the voice input. The natural language processing model can predict a similarity between one or more of the predefined user intention(s) and the instance of voice input (e.g., derived transcript of a user utterance), and output one or more of the highest ranked (e.g., most similar) predefined user intention(s).

In some implementations, machine learning model(s) can be trained to derive user intention from user utterances (e.g., transcripts of voice input). For example, smart digital agents (e.g., chatbots), can comprise layer(s) that derive initial user intentions prior to generating a chat response for a user. Analytical model(s) 440 can comprise a similar trained machine learning model that derives user intention such that disambiguation and control layer 504 can facilitate the functionality desired by the user. In some examples, these derived user intentions are not based on a predefined set of user intentions, but rather are derived by the trained machine learning model(s).

Disambiguation manager 434 can select target virtual object 508 using the voice input/transcription and the derived user intention(s). In examples were the derived user intention(s) are selected from a set of predefined intentions, the derived user intentions may comprise a predefined relationship with one or more virtual objects. For example, the set of predefined intentions may be registered by individual ones of virtual objects 506 (e.g., virtual objects available at the XR system), and thus each predefined intention can comprise a predefined relationship with one or more of virtual objects 506. In some implementations, disambiguation manager 434 can select target virtual object 508 based on a predefined relationship with one or more of the derived intentions.

In some implementations, the user's interaction history (e.g., recent interaction history over minutes or hours, long-term interaction history over days, weeks, or months, most commonly interacted with virtual objects, most interacted with virtual objects in a given physical context, etc.) with virtual objects 506 can be stored and used by disambiguation manager 434 to select target virtual object 508. For example, where a user was recently (e.g., over the last few minutes) interacting with a given one of virtual objects 506, it is likely that the user intends to continue interacting with this virtual object. Moreover, the user may utter similar phrases or commands that intend to interact with a given one of virtual objects 506. Disambiguation manager 434 and/or analytical model(s) 440 can learn such user trends over time to facilitate selecting target virtual object 508.

In some implementations, input processor 438 can resolve a focus metric from tracked user gaze and/or a user ray projection (e.g., from the user's body and/or a hand-held controller), such as focus direction, focus location within the XR environment, and the like. Disambiguation manager 434 can select target virtual object 608 based on this focus metric, for example based on: a proximity between a displayed virtual object and the focus location within the XR environment, a determination whether the focus direction overlaps with the location for a virtual object within the XR environment, and the like.

In some implementations, analytical model(s) 440, such as trained machine learning model(s), can be configured to predict a target virtual object based on the derived user intentions, voice input 502 (or voice input transcript), and/or predefined relationships between the derived user intentions and virtual objects 506. For example, analytical model(s) 440 can comprise a large language model, or any other suitable natural language processing model, that is trained to understand the relationships among different conceptual elements. This large language model or natural language processing model can predict the target virtual object using one or more of the following data elements as input: identifiers and/or functional definitions of virtual objects 506, the language of voice input 502 (e.g., transcript), the derived intentions from voice input 502, and/or the user's interaction history. For example, the identifiers and/or functional definitions of virtual objects 506 can comprise a definition of the virtual object, the functional capabilities of the virtual object, and/or the user's interaction history with the virtual object. Because the large language model and/or natural language processing model are trained to understand how language concepts relate to one another, the model(s) can predict the virtual object from virtual objects 506 that is most likely to relate to voice input 502 and the derived intentions from the voice input (e.g., the model(s) can select target virtual object 508).

Once target virtual object 508 is selected, virtual object controller 436 can generate target virtual object input 510, which can control target virtual object 506 based on the contents of voice input 502. FIG. 5C is a conceptual diagram of an example target virtual object input data format. Diagram 5000 illustrates disambiguation and control layer 504, target virtual object input 510, voice transcript portion(s) 520, entities from voice input 522, and derived intention(s) 524, as well as analytical model(s) 440, virtual object input type(s) 442, and virtual object controller 436 from FIG. 4.

In some implementations, virtual object input type(s) 442 can be different input types for each of virtual objects 506. For example, the virtual objects that the XR system is capable of displaying can register different types of input that can be used to control the virtual objects. In other words, virtual object input type(s) 442 can store different input types for each of virtual objects 506, where the different input types per virtual object comprise different structures (e.g., input parameters). In some implementations, the managing application(s) that manage virtual objects 506 can register input type(s) 442 with disambiguation and control layer 504. In some implementations, disambiguation and control layer 504 can interrogate interface(s) used to interact with the managing applications/virtual objects 506 to catalogue the different input type(s) 442.

In the illustrated example of FIG. 5B, where disambiguation and control layer 504 selects target virtual object 508 for voice input 502, virtual object controller 436 can access the different ones of input type(s) 442 that correspond to (e.g., are registered by) target virtual object 508 and select one of these input types for voice input 502. In some implementations, analytical model(s) 440 can predict the one or more input type(s) 442 for voice input 502. For example, analytical model(s) 440 can include a machine learning model trained to select from among the input type(s) 442 that correspond to target virtual object 408 using: voice input 502 and/or the transcript of the voice input; the derived user intentions; the user interaction history with target virtual object 508, and any other suitable features.

In another example, analytical models 440 can include a rule-based model that matches elements of voice input 502 to an input type(s) 442 that corresponds to target virtual object 508. For example, voice input can include the utterance “play music from artist A”. The derived intention(s) from voice input 502 can include the verb “play music”. Based on the derived intention(s), analytical models 440 can match voice input 502 to a subset of input type(s) 442 for target virtual object 508 related to playing music. In some examples, multiple of input type(s) 442 for target virtual object 508 may relate to playing music. Accordingly, analytical models 440 may derive parameter(s) from voice input 502 related to the derived intention(s) “play music”, for instance using one or more natural language processing models. In this example, the parameter can be “artist A”. From the subset of input type(s) 442 that correspond to target virtual object 508 and relate to playing music, analytical models 440 can select the one of input type(s) 442 that corresponds to an artist parameter. In some implementations, trained machine learning model(s), rule-based model(s), or a combination of these can predict the input type using one or more of the voice input (or transcript), derived intention(s), target virtual object interaction history, or any combination thereof. Any other suitable technique can be used to select from input type(s) 442.

Once the input type from input type(s) 442 is selected for target virtual object 508, target virtual object input 510 can be generated according to the data structure of the selected one of input type(s) 442. As illustrated in diagram 5000, target virtual object input 510 can include portion(s) of voice transcript 520, entities from voice input 522, and/or derived intention(s) 524. For example, portion(s) of voice transcript 520 can be language that the user intends target virtual object 508 to say or sing (e.g., “sing ‘I want to dance with somebody’ like in the song”), parameters related to a virtual object/application function, or any other suitable excerpt(s) from the voice transcript.

Derived intention(s) 524 can be the intentions derived for the voice input (e.g., by input processor 438 of FIG. 4), such as verbs, intended application/virtual object functionality, and the like. Entities from voice input 522 can be entities related to portion(s) of voice transcript 520 and/or derived intention(s) 524. For example, where the selected input type from input type(s) 442 includes one or more additional parameters related to a virtual object/application functionality, entities from voice input 522 can comprise these derived parameters (e.g., the artist, song title, and/or album of a song, the type or genre of dance, a type of image or video to play, etc.). In some implementations, analytical model(s) 440 can be used to derive the entities from voice input 522 that match the selected one of input type(s) 442.

In some implementations, target virtual object input 510 can be provided to application(s) that manage target object 506. For example, disambiguation and control layer 504 can be native software to an XR system, while the managing application(s) can be third-party XR applications. In some implementations, security policies for the XR system and/or the user may restrict access to the raw user voice input (e.g., voice input 502 of FIG. 5A) to native software or select ones of third-party XR applications. Disambiguation and control layer 504 selectively passes information based on voice input 502 (rather than the raw voice input) to the managing application(s) to enforce such security policies.

In some implementations, execution via the managing application(s) using target virtual object input 510 can implement the control of virtual object 508 based on voice input 502. For example, the managing application(s) can execute application functionality using the information contained in target virtual object input 510 to: play music from a particular artist or album; cause a displayed virtual object to dance, change clothes, or perform any other action or animation; cause dynamic display of a virtual object; remove the display of a virtual object, or cause any other suitable display change for the virtual object.

In some implementations, target virtual object input 510 may provide the managing application(s) insufficient data to execute and/or to control target virtual object 508. Descriptions with reference to process 900 of FIG. 9 describe a feedback mechanism that prompts the user for additional information when the managing application(s) receive insufficient data.

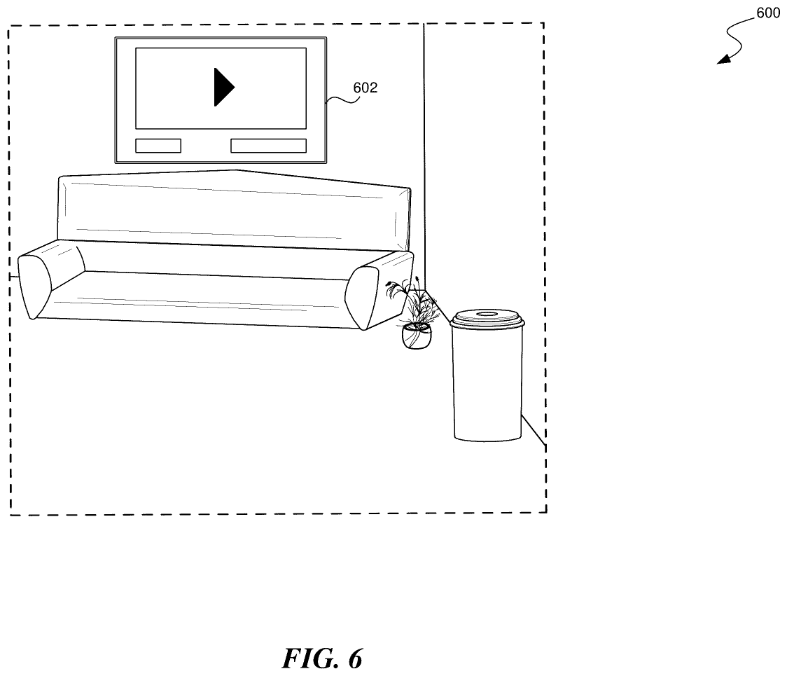

FIG. 6 is a conceptual diagram of an example of launching a targeted virtual object in an artificial reality environment. XR environment 600 may comprise a MR environment with a real-world environment that lacks virtual objects prior to dynamic display of virtual object 602. In response to voice input from a user that targets virtual object 602, an application that manages virtual object 602 can be provided structured input that causes the application to dynamically display virtual object 602. For example, a disambiguation and control layer can select, based on the voice input from the user, virtual object 602 as the target object from a plurality of potential virtual objects (not displayed), generate the structured input according to a predefined input type for virtual object 602, and provide the managing application (e.g., a third-party XR application) the structured input. In response, the managing application can execute in coordination with software native to the XR system (e.g., XR system shell, runtime environment, etc.) to dynamically display virtual object 602.

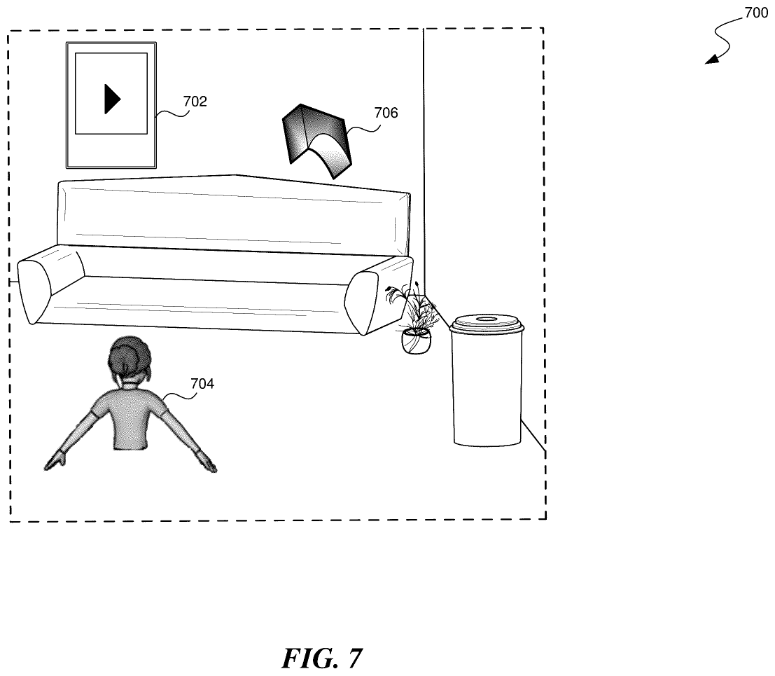

FIG. 7 is a conceptual diagram of an example of selecting and controlling a targeted virtual object among multiple virtual objects in an artificial reality environment. XR environment 700 may comprise an MR environment with a real-world environment and displayed virtual objects 702, 704, and 706 (e.g., displayed prior to receiving voice input from a user). In response to voice input from the user, a disambiguation and control layer can select, based on the voice input, virtual object 704 as the target object from a plurality of potential virtual objects (including virtual objects 702 and 706), generate structured input according to a predefined input type for virtual object 704, and provide an application that manages virtual object 704 (e.g., a third-party XR application) the structured input. In response, the managing application can execute in coordination with software native to the XR system (e.g., XR system shell, runtime environment, etc.) to control virtual object 704. Control of virtual object 704 can include causing: virtual object animation (e.g., dancing, changes clothes, singing, talking, etc.); change to text displayed by the virtual object (e.g., a song title of a song being played by a music player virtual object, news displayed by a news virtual object, etc.), and any other suitable display change.

Those skilled in the art will appreciate that the components illustrated in FIGS. 1-7 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 8 is a flow diagram illustrating a process used in some implementations of the present technology for applying voice controls to a target virtual object in an artificial reality environment. Process 800 can be performed by an XR system operated by a user. In some implementations, process 800 can be triggered in response to voice input from the user.

At block 802, process 800 can receive voice input from the user. For example, the XR system can display an XR environment to a user and, during the display, receive voice input from the user via one or more microphones. The voice input can be multiple words, a phrase, or an instruction from the user.

At block 804, process 800 can determine user intentions from the voice input. For example, user intentions can be determined for the voice input from a predefined set of user intentions. In some implementations, analytical model(s) can match the voice input and/or a transcript of the voice input to one or more of the predefined user intentions. In another example, the user intentions derived by analytical model(s) may not be predefined, and may comprise any suitable elements of the voice input (e.g., verbs, language that modifies the verbs, etc.).

At block 806, process 800 can select a target virtual object from plurality of potential virtual objects. For example, the disambiguation and control layer can select the target virtual object from among a plurality of potential virtual objects using the analytical model(s). In some implementations, the target virtual object can be obtained as a highest ranked virtual object from among the plurality of potential virtual objects by applying the analytical model(s) to the one or more user intentions and the voice input/transcript of the voice input. In some implementations, the target virtual object can be a virtual object that can be created by an available application (e.g., based or registrations of virtual objects by applications with the system shell) but that has not yet been instantiated in the artificial reality environment.

In some implementations, a user interaction history with the virtual objects can be determined and used to select the target virtual object. For example, the user's interaction history (e.g., recent interaction history over minutes or hours, long-term interaction history over days, weeks, or months, etc.) with virtual objects displayed by the XR system can be stored and used to select the target virtual object. In some implementations, the target virtual object can be obtained as a highest ranked virtual object from among the plurality of potential virtual objects by applying the analytical model(s) (e.g., a trained machine learning model) to 1) the one or more user intentions, 2) the voice input/transcript of the voice input, and 3) the user interaction history.

In some implementations, a focus metric can be resolved for the user, such as from tracked user gaze and/or a user ray projection (e.g., from the user's body and/or a hand-held controller). Examples of the focus metric include focus direction, focus location within the XR environment, and the like. The target virtual object can be selected based on this focus metric, for example based on: a proximity between the displayed target virtual object and the focus location within the XR environment, a determination whether the focus direction overlaps with the location for the target virtual object within the XR environment, and the like. In some implementations, selecting the target virtual object can include identifying A) a direction for user focus and/or B) one or more proximity measures to one or more displayed virtual objects with respect to the user focus, where the target virtual object is obtained as the highest ranked virtual object from among the potential virtual objects by applying the analytical model(s) (e.g., a trained machine learning model) to 1) the one or more user intentions, 2) the user interaction history, and 3) the direction for the user focus and/or the one or more proximity measures.

At block 808, process 800 can access a set of candidate inputs predefined for the target virtual object. For example, the virtual objects capable of display at an XR system can comprise a set of predefined candidate inputs that can be used to control the virtual objects. In some implementations, the application(s) that manage the virtual objects can register the set(s) of candidate inputs. In another example, the disambiguation and control layer can interrogate interfaces for interacting with the virtual objects to catalogue the candidate inputs.

In some implementations, each candidate input comprises a predefined structure. An example structure can be: virtual object function; parameter 1; and parameter 2. Where the target virtual object comprises a music player, the example structure can be: play music; artist name; song title. The different candidate inputs and different predefined structures can correspond to different virtual object/application functions and/or different sets of parameters.

At block 810, process 800 can select a candidate input from a set of candidate inputs for the target virtual object. For example, analytical model(s), such as a trained machine learning model, can be applied to the set of candidate inputs, the voice input (or transcript of the voice input), the determined intentions, or any combination thereof to select one of the candidate inputs. The selected candidate input can be a prediction, by the analytical model(s), that represents the most likely candidate input from the set of candidate inputs that matches the voice input provided by the user.

At block 812, process 800 can generate target virtual object input according to the selected candidate input. For example, the disambiguation and control layer can generate, using the voice input and determined user intentions, target virtual object input according to the predefined structure for the selected one of the candidate inputs. In some implementations, the generated target virtual object input can comprise one or more indicators of the voice input. For example, the one or more indicators can be generated in accordance with the structure for the selected one of the candidate inputs.

In some implementations, the disambiguation and control layer can generate the one or more indicators that comprise the target virtual object input using the voice input/transcript and the determined user intentions. The generated one or more indicators can be: a transcript of at least a portion of the voice input; at least one of the determined user intentions; entities derived from the voice input/transcript that correspond to a structure of the selected candidate input (e.g., parameters); and the like.

At block 814, process 800 can control the target virtual object using the generated target virtual object input. For example, the disambiguation and control layer can provide, to the target virtual object, the target virtual object input such that a display of the target virtual object is dynamically generated and/or an existing display of the target virtual object is dynamically altered. In some implementations, the target virtual object is dynamically controlled via executing one or more applications that manage the target virtual object, where the one or more applications process the target virtual object input and dynamically control the target virtual object by: dynamically generating the display of the target virtual object and/or dynamically altering the existing display of the target virtual object. The disambiguation and control layer can also enforce security policies. For example, the disambiguation and control layer can secure the voice input from the one or more applications that manage the target virtual object to enforce a privacy protocol with respect to the user.

FIG. 9 is a flow diagram illustrating a process used in some implementations of the present technology for implementing controls via generated virtual object input. Process 900 can be performed by an XR system operated by a user. In some implementations, process 900 can be triggered based on voice input from the user, and target virtual object input generated in response to the voice input. For example, process 900 can be part of or can be performed in combination with block 814 of FIG. 8.

At block 902, process 900 can provide target virtual object input to managing application(s). In some implementations, performing process 800 of FIG. 8 can select, based on received voice input from a user, a target virtual object and generate target virtual object input configured to control the target virtual object. For example, the target virtual object input can be generated according to a specific structure (e.g., according to the candidate input type selected for the voice input). The generated target virtual object input can be provided to application(s) that manage the target virtual object. For example, native XR system software (e.g., system shell, runtime environment, etc.) can control the target virtual object via executing the managing application(s) using the target virtual object input.

At block 904, process 900 can determine whether the target virtual object input is sufficient. For example, the managing application(s) may control the target virtual object when sufficient data is provided to the application(s) via the target virtual object input. However, in some scenarios the, the target virtual object input may provide insufficient data, and the managing application(s) may send feedback that requests additional data to the native XR system software. When such feedback is received from the managing application(s), it can be determined that the target virtual object input is insufficient. When feedback requesting additional information is not received from the managing application(s), it can be determined that the target virtual object input is sufficient for controlling the target virtual object. When the target virtual object input is sufficient, process 900 can progress to block 906. When the target virtual object input is not sufficient, process 900 can progress to block 908.

At block 906, process 900 can control the target virtual object via execution of the managing application(s). For example, when the target virtual object input provided to the managing application(s) is sufficient, the managing application(s) can execute to control the target virtual object. Example control includes dynamically displaying the target virtual object, removing a display of the target virtual object, minimizing the target virtual object from a full display (e.g., avatar, animated character, full-body character, three-dimensional object, etc.) to a minimized display (e.g., static character, partial character, such as a half-body character, two-dimensional object, etc.), altering the displayed content (e.g., text, images, etc.) of the target virtual object, or any other suitable virtual object control.

At block 908, process 900 can process feedback from the managing application(s). For example, the feedback may request additional information so that the managing application(s) can execute to control the target virtual object. The feedback may include a specific prompt to communicate to the user, such as “please select one of the following options . . . ”, “can you be more specific about . . . ”, and the like. In another example, the feedback can comprise an error message, such as “insufficient parameters”, “missing parameter”, and the like, and the native XR system software can interpret the error message to obtain additional data. For example, analytical model(s) (e.g., machine learning models, rule-based models, or a combination thereof) can be trained to interpret error messages from managing application(s).

At block 910, process 900 can generate prompt(s) for additional voice input based on the processed feedback. For example, the prompt(s) can comprise the feedback from the managing application(s) when the managing application(s) provide specific prompts. In another example, trained machine learning model(s) can be used to interpret an error message from the managing application(s) and generate prompts to obtain missing information. For example, when the error message indicates a missing parameter, the trained machine learning model(s) can: compare the generated target virtual object input to the error message to determine which parameter is missing; and generate a prompt to the user to obtain the missing parameter. At block 912, process 900 can receive additional voice input from the user in response to the prompt(s).

At block 914, process 900 can augment the target virtual object input based on the additional voice input. For example, a transcript of portion(s) of the additional voice input can be appended to the target virtual object input. In another example, analytical model(s) can interpret the additional voice input and augment the target virtual object input. For example, missing parameter(s) (e.g., as indicated by an error message received from the managing application(s)) can be derived from the additional voice input, and the target virtual object input can be augmented with the missing parameter(s).

At block 916, process 900 can provide the augmented target virtual object input to the managing application(s). For example, the disambiguation and control layer (e.g., XR system native software) can provide the augmented target virtual object input to the managing application(s) such that, when the augmented target virtual object is sufficient, the managing application(s) execute and control the target virtual object. Process 900 can progress from block 916 back to block 904. For example, process 900 can iterate over blocks 904-916 until the augmented virtual object input is sufficient to control the target virtual object via execution at the managing application(s).

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for applying voice controls to a target virtual object in an artificial reality (XR) environment, the method comprising:
receiving voice input;
selecting, for the voice input using a disambiguation layer, the target virtual object from among a plurality of potential virtual objects by:
determining, using the voice input, one or more user intentions from a predefined set of user intentions;
accessing a stored user interaction history with the one or more virtual objects; and
obtaining the target virtual object as a highest ranked virtual object from among the potential virtual objects by applying an analytical model to the one or more user intentions and the user interaction history;
accessing a set of candidate input types predefined for the target virtual object, wherein each candidate input type comprises a predefined structure;
applying a machine learning model, to the set of candidate input types and 1) one or more portions of the voice input, and/or 2) the one or more user intentions, to select one of the candidate input types;
generating, by the disambiguation layer using the voice input and determined user intentions, target virtual object input according to the predefined structure for the selected one of the candidate input types; and
providing, for the target virtual object, the target virtual object input such that a display of the target virtual object is dynamically generated and/or an existing display of the target virtual object is dynamically altered.

2. The method of claim 1, wherein selecting the target virtual object further comprises:
identifying A) a direction for user focus and/or B) one or more proximity measures to one or more displayed virtual objects with respect to the user focus, wherein the target virtual object is obtained as the highest ranked virtual object from among the potential virtual objects by applying the analytical model to 1) the one or more user intentions, 2) the user interaction history, and 3) the direction for the user focus and/or the one or more proximity measures.

3. The method of claim 1, wherein the user focus comprises an input metric based on tracked user gaze and/or a ray projection via tracked user body movement.

4. The method of claim 1, wherein the providing the target virtual object input further comprises:
dynamically controlling the target virtual object via executing one or more functions of one or more applications that manage the target virtual object, wherein the one or more applications process the target virtual object input and dynamically control the target virtual object by: dynamically generating the display of the target virtual object and/or dynamically altering the existing display of the target virtual object.

5. The method of claim 4, wherein the disambiguation layer secures the voice input from the one or more applications that manage the target virtual object to enforce a privacy protocol with respect to a user.

6. The method of claim 5, wherein generating the target virtual object input further comprises:
generating, by the disambiguation layer using the voice input and the determined user intentions, one or more indicators that comprise the target virtual object input, wherein the one or more indicators comprise a transcript of at least a portion of the voice input.

7. The method of claim 6, wherein the one or more indicators are generated in accordance with the predefined structure for the selected one of the candidate input types.

8. The method of claim 6, wherein the one or more indicators comprise at least one of the determined user intentions.

9. The method of claim 4, wherein the set of candidate input types and their predefined structures are registered with the disambiguation layer by the one or more applications that manage the target virtual object.

10. The method of claim 4, wherein dynamically controlling the target virtual object via executing the one or more applications further comprises:
in response to feedback from the one or more applications, prompting a user for additional voice input; and
augmenting the target virtual object input using additional voice input received from the user, wherein the one or more applications process the augmented target virtual object input to dynamically control the target virtual object.

11. The method of claim 1, wherein the analytical model comprises another trained machine learning model and the target virtual object is obtained as the highest ranked virtual object from among the potential virtual objects by applying the another trained machine learning model to 1) the one or more user intentions, 2) the user interaction history, and 3) the voice input or a transcript of the voice input.

12. A computer-readable storage medium storing instructions that, when executed by a computing system, cause the computing system to perform a process for applying voice controls to a target virtual object (VO) in an artificial reality (XR) environment, the process comprising:
receiving voice input;
selecting the target VO by:
determining, using the voice input, one or more user intentions;
obtaining the target VO from among potential VOs by applying an analytical model to at least a portion of the voice input and the one or more user intentions;
accessing a set of candidate input types for the target VO that each comprise a predefined structure;
applying a machine learning model, to the set of candidate input types and 1) the voice input, and/or 2) the one or more user intentions, to select one of the candidate input types;
generating, using the voice input and the one or more user intentions, target VO input according to the predefined structure for the selected candidate input type; and
providing, for the target VO, the target VO input such that a display of the target VO is dynamically generated and/or dynamically altered.

13. The computer-readable storage medium of claim 12, wherein the providing the target VO input further comprises:
dynamically controlling the target VO via executing one or more functions of one or more applications that manage the target VO, wherein the one or more applications process the target VO input and dynamically control the target VO by: dynamically generating a display of the target VO and/or dynamically altering an existing display of the target VO.

14. The computer-readable storage medium of claim 13, wherein a disambiguation layer selects the target VO and generates the target VO input, and the disambiguation layer secures the voice input from the one or more applications that manage the target VO to enforce a privacy protocol with respect to a user.

15. The computer-readable storage medium of claim 14, wherein generating the target VO input further comprises:
generating, by the disambiguation layer using the voice input and the one or more user intentions, one or more indicators that comprise the target VO input, wherein the one or more indicators comprise a transcript of at least a portion of the voice input.

16. The computer-readable storage medium of claim 15, wherein the one or more indicators are generated in accordance with the predefined structure for the selected one of the candidate input types.

17. The computer-readable storage medium of claim 15, wherein the one or more indicators comprise at least one of the determined user intentions.

18. The computer-readable storage medium of claim 12, wherein the analytical model comprises another trained machine learning model and the target virtual object is obtained as the highest ranked virtual object from among the potential virtual objects by applying the another trained machine learning model to at least a portion of the voice input, and the one or more user intentions.

19. A computing system for applying voice controls to a target virtual object (VO) in an artificial reality (XR) environment, the computing system comprising:
one or more processors; and
one or more memories storing instructions that, when executed by the one or more processors, cause the computing system to perform a process comprising:
receiving voice input;
selecting the target VO by:
determining, using the voice input, one or more user intentions;
obtaining the target VO from among potential VOs by applying an analytical model to at least a portion of the voice input and the one or more user intentions;
accessing a set of candidate input types for the target VO that each comprise a predefined structure;
applying a machine learning model, to the set of candidate input types and 1) the voice input, and/or 2) the one or more user intentions, to select one of the candidate input types;
generating, using the voice input and the one or more user intentions, target VO input according to the predefined structure for the selected candidate input type; and
providing, for the target VO, the target VO input such that a display of the target VO is dynamically generated and/or dynamically altered.

20. The computing system of claim 19, wherein the providing the target VO input comprises:
dynamically controlling the target VO via executing one or more functions of one or more applications that manage the target VO, wherein the one or more applications process the target VO input and dynamically control the target VO by: dynamically generating a display of the target VO and/or dynamically altering an existing display of the target VO.
